(19) United States
(12) Patent Application Publication
(10) Pub. No.: US 2004/0021977 A1
(43) Pub. Date: Feb. 5, 2004

(54) Compensating for coherent runout error in a data-storage device

(76) Inventors: ChoonKiat Lim, Singapore (SG); Xiong Liu, Singapore (SG); Qiang Bi, Singapore (SG); Yong Y. Yang, Singapore (SG)

Correspondence Address: David K. Lucente, Seagate Technology LLC, Intellectual Property - COL2LGL, 389 Disc Drive, Longmont, CO, 80503, US

(21) Appl. No.: 10/376,168

(22) Filed: Feb. 28, 2003

Related U.S. Application Data
(60) Provisional application No. 60/400,367, filed on Aug. 1, 2002.

(51) Int. Cl. G11B 5/596

(52) U.S. Cl. 360/77.04

(57) ABSTRACT

Disclosed are methods and systems for more accurately measuring the performance of a data-storage device by compensating for the repeatable runout (RRO) errors that are written-in to tracks during manufacture. During the manufacturing process, the disc is divided into zones containing a number of tracks. A representative RRO, known as the coherent RRO (CRRO), in each zone is obtained by sampling the position error signal (PES) of some or all of the tracks in each zone and, in one embodiment, using the average PES for the zone as the CRRO. The CRRO, which is the majority of the PES, is removed from the PES to create a corrected error signal (CES). The CES is used to evaluate the performance of the data-storage device rather than the PES. Because the CRRO does not affect the performance of the data-storage device, removing it results in a more accurate measurement.

### RELATED APPLICATIONS

This application claims priority of U.S. provisional application Serial No. 60/400,367, filed Aug. 1, 2002.

### FIELD OF THE INVENTION

This invention relates generally to the field of rotating, data-storage devices, and more particularly, to reducing repeatable runout introduced during the servo track writing process.

### BACKGROUND OF THE INVENTION

Disc drives read and write information along concentric tracks formed on discs. To locate a particular track on a disc, disc drives may use servo fields on the disc. These fields are utilized by a servo subsystem to position a head over a particular track. Servo writers write the servo fields onto the disc in tracks when the disc drive is manufactured and are thereafter simply read by the disc drive to determine position. Hereinafter, the path defined by the servo fields shall be referred to as the “servo track” to distinguish it from a data track.

Ideally, a head following the center of a servo track moves along a perfectly circular path around the disc. In such an ideal case, the servo track and data track would be identical. In reality, as a head attempts to follow a track two types of errors will cause it to be unable to follow the track, a situation referred to as track misregistration. The first type of error is referred to as non-repeatable runout error (or NRRO). NRRO is caused by such things as shocks to the disc drive, windage, resonance of the actuator, or disc flutter. NRRO may cause a discrete episode of track misregistration but does not affect the track registration (i.e. the following of the center of the track) in subsequent attempts.

Repeatable runout error (RRO), on the other hand, refers to those errors that consistently and repeatably cause track misregistration. While RRO may be caused by several factors, one of the most important is the non-ideality of servo tracks. Servo tracks typically do not follow an ideal path due to “written-in” errors that arise during the creation of the servo fields. Written-in errors occur because of movement in the write head used to produce the servo fields during manufacture. In essence, those forces that can cause NRRO during drive operation also may act on the servo write head and cause written-in error during drive manufacture. A head attempting to follow a servo track must continuously compensate for this written-in error and, depending on the non-ideality of the servo track, the servo system of the drive may not be able to compensate adequately enough to prevent servo track misregistration. Additionally, the movements of the head as it attempts to follow the non-ideal shaped servo tracks may itself be a cause track misregistration.

Disc drives manufacturers evaluate the performance of drives during the manufacturing process and the ability to certify the drive's performance has become important. In addition, during normal drive operation the drive will continuously evaluate its performance as well. Many of the performance parameters evaluated both during operation and certification testing are dependent on track misregistration. In current disc drives, NRRO during operation has greatly reduced due to the adoption of the fluid bearing motor. However, now RRO has become the dominant error responsible for track misregistration, and so is the dominant error affecting the drive's performance. This has resulted in a need for techniques for compensating for RRO when evaluating and certifying the performance of the drive.

One existing technique for compensating for RRO, known as the zero acceleration path (ZAP) method, involves storing time-domain compensation values in the form of a compensation table on discs in the disc drive. Examples of the ZAP technique can be found in Szita, G., U.S. Pat. No. 6,411,461 and Morris, et al., U.S. Pat. No. 6,449,116. These compensation values are injected into the servo loop to compensate for RRO. Typically, a time-domain compensation value for each servo sector is required to be stored in the compensation table. Essentially, the ZAP method stores a value for each servo sector that indicates how far off from the ideal path the servo sector is.

While effective, the ZAP method has at least two major drawbacks. Determining the ZAP value for each sector is very computationally intensive. Therefore, it requires a considerable amount of time during the drive manufacturing process to determine the compensation value for each servo sector. In addition, the resulting very large compensation table must be stored on discs in the drive, thus reducing the effective storage capacity available to the customer. Also, ZAP techniques require intensive processing of the ZAP value after it is retrieved from storage, thus requiring more on-board processing and consequently increasing the unit cost of the device. While the tables may be reduced in size by using compression techniques, the benefit in size reduction is often offset by an increased demand placed on the disc drive's electronics to quickly decompress and otherwise manipulate the data stored in the tables.

Accordingly there is a need for a method to compensate for RRO when evaluating and certifying the performance of the drive that does not require a large amount of storage capacity on the disc, that is quick to perform (both during the manufacturing process and during normal drive operation) and that does not require intensive processing by the disc drive. The present invention provides a solution to this and other problems, and offers other advantages over the prior art.

### SUMMARY OF THE INVENTION

Against this backdrop the present invention has been developed. An embodiment of the present invention is a method for more accurately measuring the performance of a data-storage device by compensating for the repeatable and written-in errors. During the manufacturing process, the disc is divided into zones containing a number of tracks. A representative RRO, known as the coherent RRO (CRRO), in each zone is obtained by sampling the position error signal (PES) of some or all of the tracks in each zone and, in one embodiment, using the average PES for the zone as the CRRO. The CRRO, which is the majority of the PES signal, is removed from the PES to create a corrected error signal (CES). The CES is then used to evaluate the performance of the data-storage device rather than the PES. Because the CRRO does not actually affect the performance of the data-storage device, removing it from the signal that is used to measure the data-storage device's performance results in a more accurate measurement.

Other methods of determining a representative CRRO from the PES values of the zone are possible, as long as the CRRO value is representative of the RRO of the tracks in a zone. The CRRO values for the zones are stored in a lookup table referred to as the compensation value table. When the data-storage device evaluates its performance, the appropriate CRRO value is retrieved from the table and subtracted from the PES.

The compensation value table may be periodically updated to take into account any changes in the RRO of the tracks during the lifetime of the data-storage device. The number of zones may be predetermined or may selected in order to minimize the deviation from the CRRO value of the PES for the tracks in each zone.

These and various other features as well as advantages which characterize the present invention will be apparent from a reading of the following detailed description and a review of the associated drawings.

### BRIEF DESCRIPTION OF THE DRAWINGS

FIG. 1 is a plan view of a disc drive incorporating an embodiment of the present invention showing the primary internal components.

FIG. 2 is a top view of a section of a disc showing an ideal track and an actual servo track showing repeatable, written-in errors.

FIG. 3 is a block diagram of a typical performance evaluation system.

FIG. 4 is a block diagram of a performance evaluation system in accordance with an embodiment of the present invention.

FIG. 5 is a process flow diagram of an embodiment of the present invention.

### DETAILED DESCRIPTION

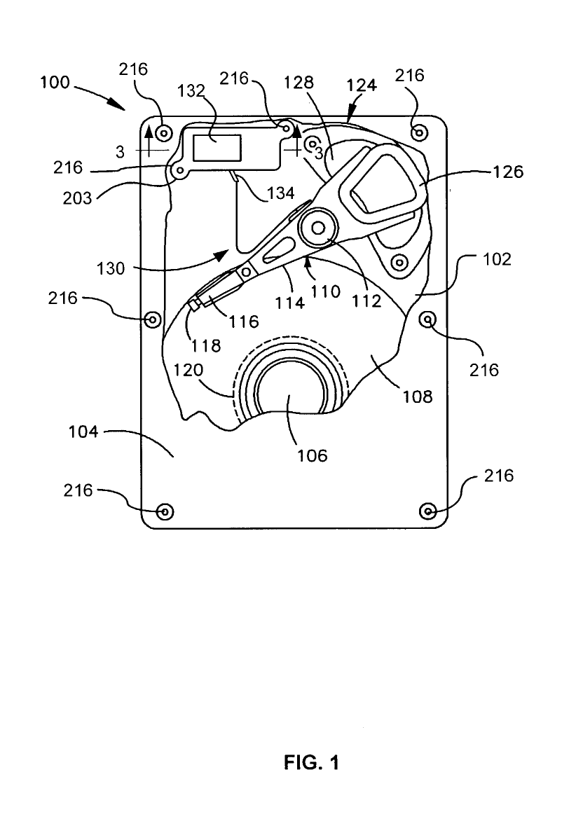

A disc drive 100 type of data-storage device constructed in accordance with a preferred embodiment of the present invention is shown in FIG. 1. The disc drive 100 includes a base 102 to which various components of the disc drive 100 are mounted. A top cover 104, shown partially cut away, cooperates with the base 102 to form an internal, sealed environment for the disc drive in a conventional manner. The components include a spindle motor 106, which rotates one or more discs 108 at a constant high speed. Information is written to and read from tracks on the discs 108 through the use of an actuator assembly 110, which rotates during a seek operation about a bearing shaft assembly 112 positioned adjacent the discs 108. The actuator assembly 110 includes a plurality of actuator arms 114 which extend towards the discs 108, with one or more flexures 116 extending from each of the actuator arms 114. Mounted at the distal end of each of the flexures 116 is a head 118, which includes an air bearing slider, enabling the head 118 to fly in close proximity above the corresponding surface of the associated disc 108.

During a seek operation, the track position of the heads 118 is controlled through the use of a voice coil motor (VCM) 124, which typically includes a coil 126 attached to the actuator assembly 110, as well as one or more permanent magnets 128 which establish a magnetic field in which the coil 126 is immersed. The controlled application of current to the coil 126 causes magnetic interaction between the permanent magnets 128 and the coil 126 so that the coil 126 moves in accordance with the well-known Lorentz relationship. As the coil 126 moves, the actuator assembly 110 pivots about the bearing shaft assembly 112, and the heads 118 are caused to move across the surfaces of the discs 108.

The spindle motor 106 is typically de-energized when the disc drive 100 is not in use for extended periods of time. The heads 118 are moved over park zones 120 near the inner diameter of the discs 108 when the drive motor is de-energized. The heads 118 are secured over the park zones 120 through the use of an actuator latch arrangement, which prevents inadvertent rotation of the actuator assembly 110 when the heads are parked.

A flex assembly 130 provides the requisite electrical connection paths for the actuator assembly 110 while allowing pivotal movement of the actuator assembly 110 during operation. The flex assembly includes a printed circuit board 132 to which head wires (not shown) are connected; the head wires being routed along the actuator arms 114 and the flexures 116 to the heads 118. The printed circuit board 132 typically includes circuitry for controlling the write currents applied to the heads 118 during a write operation and a preamplifier for amplifying read signals generated by the heads 118 during a read operation. The flex assembly terminates at a flex bracket 134 for communication through the base deck 102 to a disc drive printed circuit board (not shown) mounted to the bottom side of the disc drive 100.

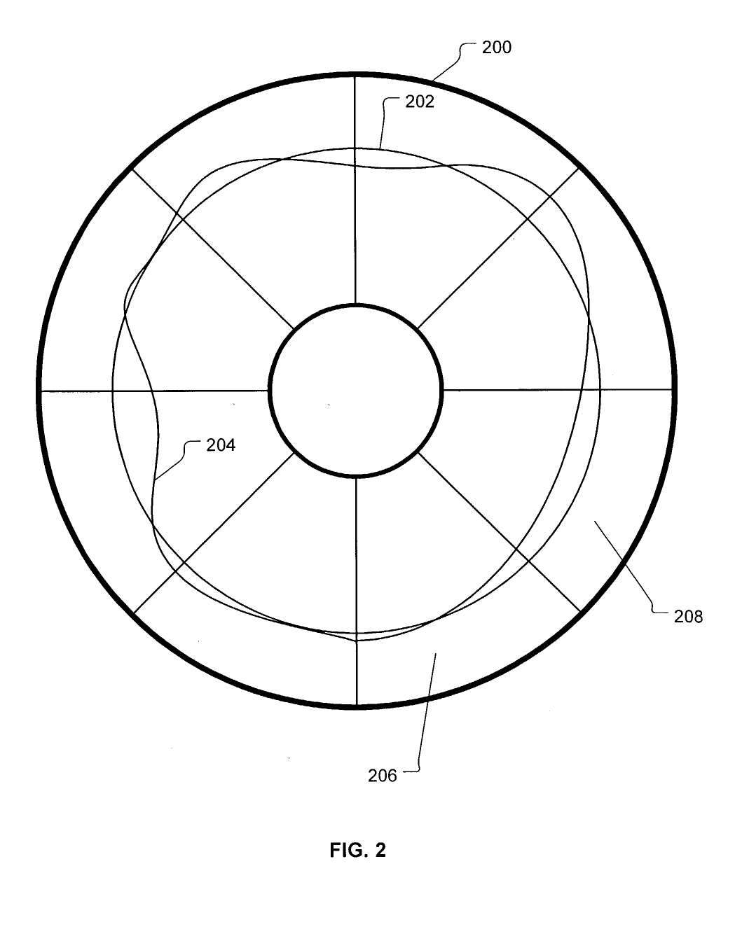

Referring now to FIG. 2, a top view of a surface 200 of a disc with an ideal, perfectly-circular track 202 and a non-ideal servo track 204 is shown. The surface 200 includes a plurality of radially extending servo fields such as servo fields 206 and 208. The servo fields include servo information that identifies the location of actual track 204 along disc surface 200.

A head attempting to write to or read from track 204 will not follow track 204 but instead will more closely follow perfectly circular track 202. A servo loop (discussed in greater detail below) monitors the registration of the track 204 and corrects for variations for the ideal track 202 in an attempt to follow the track 204. Any variation in the position of a head away from circular track 202 is considered a position error. A position error is considered a repeatable runout error (RRO) if the same error occurs each time the head passes a particular circumferential location on the disc. Thus, the portions of the servo track 204 that do not follow circular track 202 are considered written-in RROs.

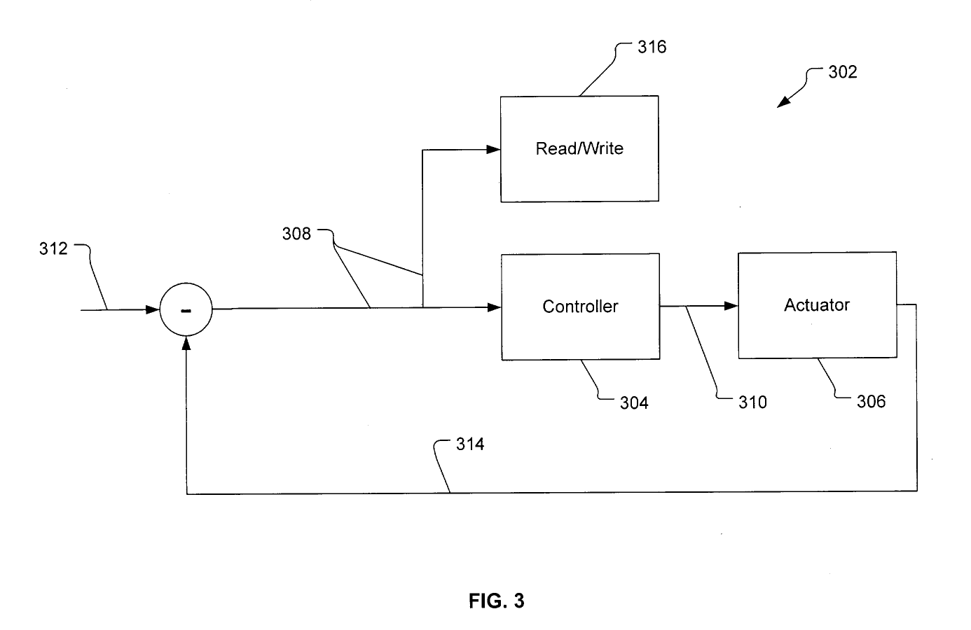

Referring to FIG. 3, a block diagram of a disc drive servo system is shown. The servo loop (generally indicated at 302) includes a controller 304 and actuator 306. To position a head on a track, a set point signal is input to the controller 304. The set point signal is indicative of where on the disc the system expects to find the target track and assumes that the track is an ideal track 202. Based on the set point signal 312, the controller 304 generates an actuator current signal 310 that is input to the actuator 306. The actuator current signal 310 drives the voice coil motor (not shown), which moves the head (not shown) to a position on the disc (not shown). The head includes a sensor (not shown) for reading servo data on a servo track, such as that contained in the servo fields 206, 208. The sensor provides an actual position signal 314 that is indicative of the actual position of the head relative to the disc. In a typical system, the actual position signal 314 is directly fed back and compared with or used to adjust the set point signal 312 via the servo loop. The adjusted signal (in this case, the set point signal 312 less the actual position signal 31.4), which can be considered a direct measurement of servo track misregistration, is referred to as the position error signal (PES) 308. In addition, in typical devices the PES 308 is also delivered to the read/write system 316. The read/write system 316 uses the PES 308 to evaluate system servo performance, e.g. determining AC squeeze, comparing with write faults threshold, write to read track misregistrations and write to write track misregistrations. Write-to-read track misregistration is the track misregistration between write head location during writing data and read head location during reading back data, resulting in off-track reading. Write-to-write track misregistration is the track misregistration between a recorded track and an adjacent track, resulting in track encroachment or track to track squeeze.

Embodiments of the present invention use a novel RRO compensation technique to adjust the PES. RRO can be divided into two components: a coherent RRO (CRRO) being a representative value for the portion of RRO that is repeatable across tracks, i.e. that exists in all RRO within a zone, or that is somehow representative of the RRO of the tracks in that zone; and incoherent RRO being that portion of RRO that is not consistent with a zone, or that portion of RRO of a track that differs from the CRRO for that zone.

In embodiments of the present invention, during the manufacturing process, the disc is divided into zones containing a selected number of tracks. For example, it is common to divide a data-storage disc into 20 zones each containing 4500 tracks. In embodiments of the present invention, a disc is divided into 20 or more CRRO zones.

The CRRO in each zone is obtained by determining a representative RRO for tracks within the zone. This is done by sampling the PES of some or all of the tracks in each zone. In some embodiments of the present invention, the PES of 100 to 200 evenly spaced tracks within a zone is sampled. The number of tracks sampled in each zone will determine how long it takes to determine the CRRO for each zone of the disc and how representative the resultant CRRO is.

Once the PES sampling for a zone has been performed, a CRRO for that zone can be determined. In one embodiment the following equation is used to determine the CRRO for a zone:

$$CRRO = \frac{1}{n} {\sum }_{i = 1}^{n} {PES}_{i}$$

In the above equation, CRRO is the value of the coherent RRO for that zone, n is the number of tracks sampled in the zone, i is the track number, and PESᵢ is the position error signal for track i determined during the sampling. PESᵢ is a vector with length of the number of sectors. The above equation represents a simple averaging of the PES of the sampled tracks in the zone. Other methods of determining a representative, or coherent, RRO may also be used, such as using a median as the coherent RRO, without deviating from the scope of this invention.

The CRRO values for each zone are collected into a CRRO compensation table. The table may be stored on a disc in the disc drive or, alternately, may be stored in the drive's memory. In an embodiment, the CRRO compensation table is stored on the system sector of the disc but is read into memory upon startup to provide quick access to the entire table during drive operation.

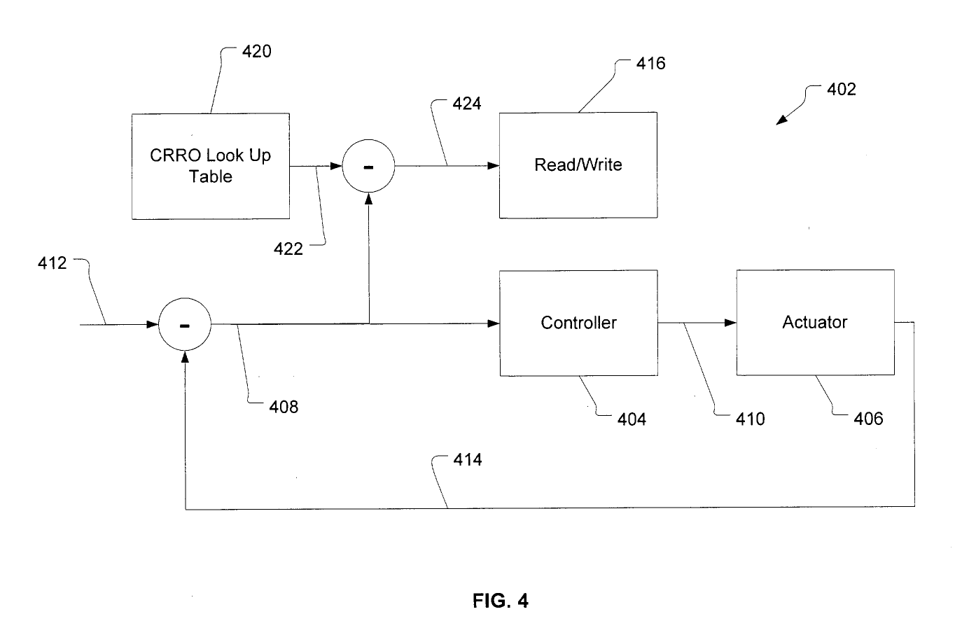

FIG. 4 is a block diagram of a performance evaluation system in accordance with the present invention utilizing a CRRO correction table. The servo loop (generally indicated at 402) includes a controller 404 and actuator 406. To position a head, a set point signal 412 is input to the controller 404. Based on the set point signal 412, the controller 404 generates an actuator current signal 410, which is input to the actuator 406. The actuator current signal 406 drives the voice coil motor (not shown), which moves the head (not shown) to a position on the disc (not shown). The head includes a sensor (not shown) for reading servo data on a servo track. The sensor provides an actual position signal 414 that is indicative of the actual position of the head relative to the disc. The actual position signal 414 is directly fed back to adjust the set point signal 412 via the servo loop.

FIG. 4 differs from FIG. 3 in that the PES 408 is modified by the CRRO compensation value instead of being directly delivered to the read/write system 416. After the PES 408 is determined, the appropriate CRRO compensation value 422 for the zone containing the set point signal 412 is retrieved from the CRRO compensation table 420. The CRRO compensation value 422 is then subtracted from the PES 408 to obtain a CRRO-corrected position error signal (CES) 424. The CES 424 is then input to the read/write system 416.

The performance evaluation system described in FIG. 4 has several benefits over that in FIG. 3. In FIG. 3, the PES 308 fed into servo control system is the same PES 308 that is used to measure system performance parameters such as AC squeeze, write fault detection capability, PES screening in certification test, and others. Again, the PES 308 contains RRO (coherent and incoherent) and NRRO, and is a direct measurement of servo track misregistration. In embodiments of the present invention, the CES 424 is input to the read/write system in order to obtain a more accurate measure of the disc drive's performance. The performance of the disc drive is evaluated based on track misregistration. It should be noted that whether the PES or the CES is used to evaluate performance, the actual performance of the disc drive does not change—just the reporting of it. Inasmuch as the PES is a measurement of servo track misregistration, it possible to use it to evaluate the performance based on servo track misregistration. However, since the PES value, in absolute terms, will be larger than the CES value, using the larger PES value will result in an underestimation of the drive's actual performance and may result in over design issues. This is especially true now that fluid bearing motor are typically used in disc drives, and RRO is now the dominant contributor to PES. When the disc is written by a Multi-Disc-Writer, the CRRO is also the majority of the total RRO.

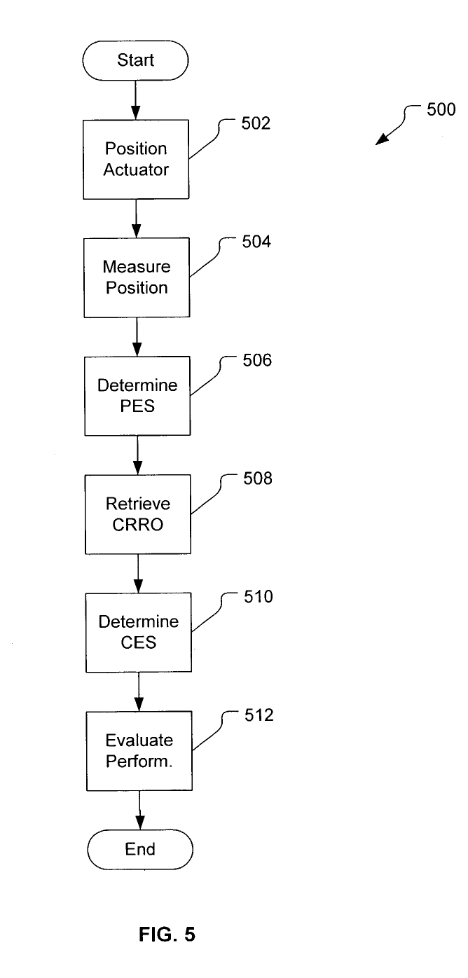

FIG. 5 shows an algorithm 500 of the above-mentioned embodiment of the present invention. Upon the initiation of a seek operation (not shown), an actuator position operation 502 positions the actuator based on a set point signal indicative of a track in a zone on a disc. The position sensor on the positioned actuator then measures the actual position of the actuator in a position measurement operation 504 and generates an actual position signal indicative of the actual position. A determining operation 506 determines the PES from the actual position signal and the set point signal. A retrieve operation 508 retrieves the appropriate coherent repeatable runout error value for the zone containing the track indicated by the set point signal. Next, a CES is generated by a generate CES operation 510. The CES is then used to evaluate the performance of the disc drive in evaluation operation 512.

Yet another aspect of the present invention is the periodic updating of the CRRO compensation table by the disc drive. Because of the relatively short amount of time necessary to produce the CRRO compensation table, checking and, if necessary, updating the table can be performed as a disc drive diagnostic. The updating can be performed automatically as part of an over all diagnostic scheme or can be user-initiated. The ability to update the table allows users to maintain system performance in the face of degradations and changes to the disc over that change the RRO of the servo tracks.

### EXAMPLE

An embodiment of the present invention was demonstrated on a 64,000 TPI Saturn drive. The RRO of continuous 2050 tracks in a zone were collected. A CRRO value was determined based on the PES of 50 evenly spaced tracks in this zone. The test result is shown in FIG. 6. Prior to compensation, the CRRO portion of the PES was 10.6 servo count. After compensation, the RRO of the CES was less than 1 servo count. In other words, more than 90% of the RRO portion of the PES was removed via the compensation method. The same experiment was also performed using 300 evenly spaced tracks to characterize the zone and a CES of only 0.4 servo count resulted, as shown in FIG. 7.

The present invention provides a method (such as 500) of evaluating performance in a data-storage device (such as 100) through the use of a compensation value table (such as 420). The method includes: positioning (in an operation such as 502) a head (such as 118) over a track (such as 204) within a predetermined zone located on a data-storage disc (such as 108); measuring (in an operation such as 504) a position of the head relative to the data-storage disc; determining (in an operation such as 506), via a servo loop (such as 402), a servo position error signal (such as 408); retrieving (in an operation such as 508) a predetermined coherent repeatable runout error value (such as 422) representative of repeatable runout errors of tracks associated with the predetermined zone; creating (in an operation such as 510) a corrected position error signal (such as 424) based on the servo position error signal (such as 408) and the coherent repeatable runout error value (such as 422); and evaluating (in an operation such as 512) at least one performance parameter indicative of the performance of the data-storage device (such as 100) using the corrected position error signal (such as 408). The method may also include certifying during manufacture, based on the results of the evaluating step, the data-storage device's performance. And the method may include periodically updating the predetermined coherent repeatable runout error values (such as 422) in the compensation value table (such as 420).

In an embodiment the coherent repeatable runout error value (such as 422) associated with the desired head position may be predetermined by averaging the coherent repeatable runout error over a group of tracks that include the desired head position or it may represent a median repeatable runout error for the tracks (such as 204). The compensation value table (such as 420) may be created during the manufacture of the data-storage device (such as 100). The compensation value table (such as 420) may be stored on the data-storage disc (such as 108).

The present invention also provides a method of creating a look up table (such as 420) for use in evaluating the performance of a data-storage device (such as 100) comprising one or more data-storage discs (such as 108). An embodiment of the method includes: dividing the one or more data-storage discs (such as 108) into a plurality of zones, wherein each zone contains a plurality of tracks (such as 204); determining a coherent repeatable runout error value (such as 422) for each of the plurality of zones, wherein the coherent repeatable runout error value for each zone is representative of repeatable runout errors of the tracks (such as 204) in that zone; and storing, on the data-storage device (such as 100), a look up table (such as 420) comprising the coherent repeatable runout error values (such as 422) for each of the plurality of zones.

An embodiment of the method further includes: determining (in an operation such as 506) a position error signal (such as 408) of each of the plurality of tracks in each zone; and averaging the position error signals (such as 408) of each of the plurality of tracks in each zone to obtain the coherent repeatable runout error value (such as 422) for each zone.

Yet another embodiment of the method may include: determining (in an operation such as 506) a position error signal (such as 408) of each of the plurality of tracks (such as 204) in each zone; determining a median position error signal of the plurality of tracks in each zone; and using the median position error signal of the plurality of tracks in each zone as the coherent repeatable runout error value (such as 422) for each zone.

Another embodiment of the method includes: determining (in an operation such as 506) the position error signal (such as 408) of each of the plurality of tracks on the one or more data-storage discs (such as 108); and dividing the one or more data-storage discs (such as 108) into a plurality of zones of adjacent tracks (such as 204) based on the position error signals (such as 408) of the tracks. A method may also include dividing the one or more data-storage discs (such as 108) into a plurality of zones of adjacent tracks (such as 204) such that the variation of the position error signals (such as 408) of the tracks within each zone is reduced.

The present invention also provides a performance evaluation system for a data-storage device (such as 100) having a performance evaluator operably coupled to a servo system (such as 402) comprising a controller (such as 404) operatively coupled to an actuator (such as 406). The performance evaluation system includes: a servo controller (such as 404) for controlling the positioning of an actuator (such as 406) that comprises a voice coil motor (such as 124), one or more heads (such as 118) for reading data on a surface of a data-storage disc (such as 108). In the embodiment, the surface of the data-storage disc is divided into a plurality of zones having a plurality of tracks (such as 204). The performance system also includes a position sensor for determining the actuator's position relative to the surface of the data-storage disc (such as 108) and a look up table (such as 420) comprising a plurality of coherent runout error values (such as 422) associated with the plurality of zones on the data-storage disc (such as 108). The performance evaluator evaluates the performance of the data-storage device (such as 100) based on data received from the position sensor and the plurality of coherent runout error values (such as 422) contained in the look up table (such as 420).

Embodiments of the performance evaluation system may be used in a hard disc drive (such as 100) utilizing magnetic data-storage discs (such as 108), an optical disc drive utilizing optical data-storage discs, or in data-storage devices utilizes removable data-storage media.

The coherent runout error values (such as 422) for each of the plurality of zones may represent an average error for the tracks within the zones.

It will be clear that the present invention is well adapted to attain the ends and advantages mentioned as well as those inherent therein. While a presently preferred embodiment has been described for purposes of this disclosure, various changes and modifications may be made which are well within the scope of the present invention. For example, the method for dividing the tracks on a data-storage disc into zones could be optimized to reduce the variation of the PES of the tracks within each zone. In one embodiment, already described, the data-storage disc is divided into some number of zones, each containing an equal number of tracks. The example given above was 20 zones each containing 4500 tracks. The modified method would first identify the PES for each track and then group sets of adjacent tracks into zones so as to reduce or minimize the range of variation of PES over the tracks within each zone. The CRRO values created by the modified method would then more closely track the actual CRRO each track in its zone, and thus further improve the drive's performance.

Furthermore, one skilled in the art will immediately recognize that the methods and apparatuses described above would be equally useful in data-storage devices other than disc drives. For example, the method could be equally useful in optical data-storage devices such as CD-ROM drives, hard disc drives that utilize optical discs instead of magnetic discs, DVD-ROM drives, and data-storage devices that utilize removable disc media. In the case of removable disc media, the CRRO compensation table may encoded on the disc media by the disc media manufacturer for use by the data-storage device or, due to the speed at which the CRRO compensation table can be built, generated and stored for each disc media upon first insertion in the data-storage device.

Numerous other changes may be made which will readily suggest themselves to those skilled in the art and which are encompassed in the spirit of the invention disclosed and as defined in the appended claims.

What is claimed is:

1. A method of evaluating performance in a rotating, data-storage device, the method comprising steps of:
creating a corrected error signal based on a servo position error signal and a predetermined coherent repeatable runout error value associated with a zone; and
evaluating at least one performance parameter indicative of the performance of the data-storage device using the corrected error signal.

2. The method according to claim 1 wherein the predetermined coherent repeatable runout error value associated with the zone is an average of coherent repeatable runout error values for tracks in the zone.

3. The method of claim 1 further comprising
certifying during manufacture, based on the results of the evaluating step, the data-storage device's performance.

4. The method of claim 1 further comprising:
creating a table of predetermined coherent repeatable runout error values during the manufacture of the data-storage device.

5. The method of claim 1 further comprising:
periodically updating the predetermined coherent repeatable runout error value.

6. The method of claim 1 wherein the predetermined coherent repeatable runout error value is stored on the data-storage disc.

7. The method of claim 1 wherein the predetermined coherent repeatable runout error value represents a median repeatable runout error for the tracks associated with the predetermined zone.

8. A performance evaluation system for a rotating, data-storage device having a performance evaluator, the performance evaluation system comprising:
a look up table having a plurality of coherent runout error values, each associated with a plurality of zones on a data-storage disc; and
the performance evaluator that evaluates the performance of the data-storage device based on data received from a position sensor and the plurality of coherent runout error values contained in the look up table.

9. The performance evaluation system of claim 8, wherein the data-storage device is a hard disc drive utilizing magnetic data-storage discs.

10. The performance evaluation system of claim 8, wherein the data-storage device is an optical disc drive utilizing optical data-storage discs.

11. The performance evaluation system of claim 8, wherein the data-storage device utilizes removable storage discs.

12. The performance evaluation system of claim 8, wherein the coherent runout error values for each of the plurality of zones represents an average error for the tracks within the zones.
